(19) United States
(12) Patent Application Publication
(10) Pub. No.: US 2020/0302541 A1
(43) Pub. Date: Sep. 24, 2020

(54) RESOURCE PROCESSING METHOD, STORAGE MEDIUM, AND COMPUTER DEVICE

(71) Applicant: TENCENT TECHNOLOGY (SHENZHEN) COMPANY LIMITED, Shenzhen (CN)

(72) Inventor: Jian Liu, Shenzhen (CN)

(73) Assignee: TENCENT TECHNOLOGY (SHENZHEN) COMPANY LIMITED, Shenzhen (CN)

(21) Appl. No.: 16/895,450

(22) Filed: Jun. 8, 2020

Related U.S. Application Data
(63) Continuation of application No. PCT/CN2019/072977, filed on Jan. 24, 2019.

(30) Foreign Application Priority Data
Feb. 2, 2018 (CN) 201810106032.8

(51) Int. Cl. G06Q 40/06; G06F 16/245; G06N 20/00; G06N 5/04

(52) U.S. Cl. CPC G06Q 40/06; G06N 5/04; G06N 20/00; G06F 16/245

(57) ABSTRACT

Provided is a resource processing method performed by a computer device. Feature data respectively corresponding to a plurality of resources are searched. A result of a comparison of feature data of a resource, among the plurality of resources, with feature data of each remaining resource among remaining resources, is respectively determined for each of the plurality of resources. Based on the result of the comparison for each of the plurality of resources, a probability that each resource wins over the remaining resources is determined.

### CROSS-REFERENCE TO RELATED APPLICATION(S)

This application is a bypass continuation application of International Application No. PCT/CN2019/072977, filed on Jan. 24, 2019, which claims priority to Chinese Patent Application No. 201810106032.8, entitled “RESOURCE PROCESSING METHOD AND APPARATUS, STORAGE MEDIUM, AND COMPUTER DEVICE”, and filed with the National Intellectual Property Administration of the People's Republic of China (PRC) on Feb. 2, 2018, the disclosures of which are incorporated herein by reference in their entireties.

### FIELD

Example embodiments of the disclosure relate to the field of computer technologies, and in particular, to a resource processing method, a storage medium, and a computer device.

### BACKGROUND

With the rapid development of the market economy, an increasing number of investors select some resources for investment. The resources may be financial assets, such as stocks or funds. Conventionally, the investors are required to spend a significant amount of time and energy to evaluate a large number of resources to select an appropriate resource so as to perform a subsequent operation.

However, when there is mass resource data related to resources, such method of relying on the investors themselves to evaluate and select resources not only takes a lot of time and energy, but also fails to perform real-time analysis of different resources, resulting in low resource processing efficiency.

### SUMMARY

One or more example embodiments provide a resource processing method, a storage medium, and a computer device that solve the problem of low resource processing efficiency in the related art and improve resource processing efficiency.

In accordance with an aspect of an example embodiment, provided is a resource processing method performed by a computer device. Feature data respectively corresponding to a plurality of resources are searched. A result of a comparison of feature data of a resource, among the plurality of resources, with feature data of each remaining resource among remaining resources, is respectively determined for each of the plurality of resources. Based on the result of the comparison for each of the plurality of resources, a probability that each resource wins over the remaining resources is determined.

In accordance with an aspect of an example embodiment, provided is a computer device including: at least one memory configured to store program code: and at least one processor configured to read the program code and operate as instructed by the program code, the program code including: searching code configured to cause at least one of the at least one processor to search for feature data respectively corresponding to a plurality of resources; first determining code configured to cause at least one of the at least one processor to respectively determine, for each of the plurality of resources, a result of a comparison of feature data of a resource, among the plurality of resources, with feature data of each remaining resource among remaining resources; and second determining code configured to cause at least one of the at least one processor to determine, based on the result of the comparison for each of the plurality of resources, a probability that each resource wins over remaining resources excluding each resource.

In accordance with an aspect of an example embodiment, provided is a non-transitory computer-readable storage medium storing computer code executable by at least one processor to cause the at least one processor to perform a resource processing method, the method including: searching for feature data respectively corresponding to a plurality of resources; respectively determining, for each of the plurality of resources, a result of a comparison of feature data of a resource, among the plurality of resources, with feature data of each remaining resource among remaining resources; and determining, based on the result of the comparison for each of the plurality of resources, a probability that each resource wins over remaining resources excluding each resource.

### BRIEF DESCRIPTION OF THE DRAWINGS

To describe the technical solutions in the example embodiments of the disclosure more clearly, the following briefly describes the accompanying drawings required for describing the example embodiments. Apparently, the accompanying drawings in the following description show merely some embodiments of the disclosure, and a person of ordinary skill in the art may still derive other drawings from these accompanying drawings without creative efforts.

FIG. 1 is an application environment diagram of a resource processing method according to an example embodiment.

FIG. 2 is a schematic flowchart of a resource processing method according to an example embodiment.

FIG. 3 is a schematic diagram of an interface of a feature factor selection page according to an example embodiment.

FIG. 4 is a schematic diagram of an interface of an evaluation indicator selection page according to an example embodiment.

FIG. 5 is a schematic diagram of an interface that displays a sorting result according to an example embodiment.

FIG. 6 is a schematic flowchart of a resource processing method according to another example embodiment.

FIG. 7 is a logic block diagram of a resource processing method according to an example embodiment.

FIG. 8 is a module structure diagram of a resource processing apparatus according to an example embodiment.

FIG. 9 is a module structure diagram of a resource processing apparatus according to another example embodiment.

FIG. 10 is an internal structure diagram of a computer device according to an example embodiment.

### DETAILED DESCRIPTION

To make the objectives, the technical solutions, and the advantages of the disclosure clearer, the following further describes example embodiments in detail with reference to the accompanying drawings. It should be understood that the example embodiments described herein are merely used to explain the disclosure, and are not intended to limit the disclosure.

As used herein, the term “and/or” includes any and all combinations of one or more of the associated listed items. Expressions such as “at least one of,” when preceding a list of elements, modify the entire list of elements and do not modify the individual elements of the list. For example, the expression “at least one of a, b, and c,” should be understood as including only a, only b, only c, both a and b, both a and c, both b and c, or all of a, b, and c.

The terms “first”, “second”, and the like may be used to describe various configuration elements, but configuration elements should not be limited by the terms. The terms are only used to distinguish one configuration element from another configuration element.

A singular expression includes multiple expressions unless the context clearly indicates otherwise. In addition, when a part is described to “include” a certain configuration element, which means that the part may further include other configuration elements, except to exclude other configuration elements unless otherwise stated.

In addition, a term “ . . . unit”, “ . . . module”, or the like described in the specification means a unit for processing at least one function or operation, which may be implemented by hardware or software, or a combination of the hardware and the software.

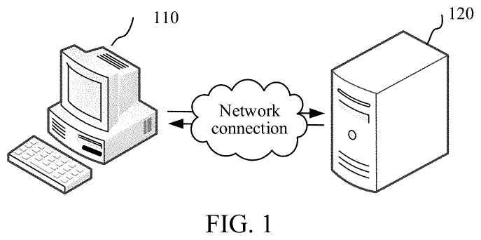

FIG. 1 is an application environment diagram of a resource processing method according to an example embodiment. Referring to FIG. 1, the resource processing method is applied to a resource processing system. The resource processing system includes a terminal 110 and a server 120. The terminal 110 and the server 120 are connected through a network. The terminal 110 may be specifically a desktop terminal or a mobile terminal. The mobile terminal may be specifically at least one of a mobile phone, a tablet computer, and a notebook computer, etc. The server 120 may be implemented by an independent server or a server cluster including a plurality of servers. It should be understood that both the terminal 110 and the server 120 may be configured to perform the resource processing method separately; and the terminal 110 and the server 120 may also be configured to perform the resource processing method jointly.

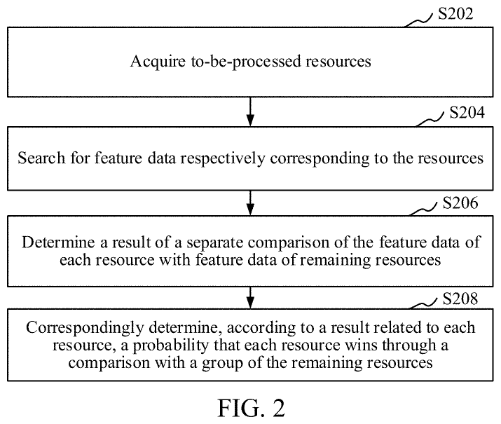

FIG. 2 is a schematic flowchart of a resource processing method according to an example embodiment. In this example embodiment, the method applied to the foregoing terminal 110 in FIG. 1 is mainly illustrated. Referring to FIG. 2, the resource processing method specifically includes the following operations S202-S208:

S202: Acquire to-be-Processed Resources.

The resources are items that may acquire ownership through the Internet. The resources may be classified into a virtual resource and a physical resource according to an attribute. The virtual resource includes, for example, an account value, a virtual image product, a virtual recharge card, game equipment, and a virtual currency. The physical resource may be any item with a physical form that may be owned by a user, such as an electronic product, a toy, a craft, or a signature photo. In an example embodiment, the resources may be financial assets. The financial assets may be, for example, stocks, funds, or futures.

The to-be-processed resources are a plurality of resources to be processed in a certain processing method. For example, the certain processing method may include counting a number of virtual image products in each category, sorting a plurality of categories of virtual image products according to the number of the virtual image products in each category, calculating a return rate of each fund, or sorting a plurality of funds according to the return rate of each fund.

In particular, after the user logs in to a terminal through a user identity, the terminal may acquire resource identifiers respectively corresponding to the resources specified by a user instruction, thereby obtaining the to-be-processed resources. The user identity is used for uniquely identifying a user. The resource identifier is used for uniquely identifying a resource. The user identity and/or the resource identifier may be a character string including at least one of a number, a letter, and a symbol.

A terminal is a computer device configured to process data that may be recognized by a computer. In other words, in the computer device, the user is usually represented by the user identity, and a resource is represented by the resource identifier. It should be understood that, for the computer device, acquiring resource identifiers corresponding to the to-be-processed resources is acquiring the to-be-processed resources. Then, the computer device processes a plurality of resource identifiers, that is, processing resources corresponding to the resource identifiers.

S204: Search for Feature Data Corresponding to the Resources Respectively.

The feature data is data reflecting a resource characteristic. The feature data is, for example, a resource share or a resource share change ratio. The resource share is a number of a resource in a unit. For example, if the resource is a virtual image product, the resource share is a number of the virtual image product, such as 10. For another example, if the resource is a stock, the resource share is a number of the stock, such as 10 shares. A growth rate of the resource share is a ratio of a change in the resource share to the resource share before the change after a period of time.

In particular, the feature data corresponding to the resources may be stored on the terminal. Such feature data are stored corresponding to the resource identifiers and are used for distinguishing which feature data belong to which resource. After acquiring the resource identifiers corresponding to the to-be-processed resources, the terminal may separately search for the feature data stored corresponding to the resources identifiers, so as to search for the feature data corresponding to the resources.

In a specific implementation, in a case that the resource is a financial asset, the feature data is specifically a feature value of the financial asset. For the feature value of the financial asset, for example, a total value of the financial asset is 100,000, or a tracking error of the year is 0.7986%.

S206: Determine a Result of a Separate Comparison of the Feature Data of Each Resource with Feature Data of Remaining Resources.

A result of a comparison of feature data of one resource with feature data of another resource is used for representing a comparison result of comparison between the two resources based on the feature data. Results of the comparison of the feature data of the two resources may include, for example but not limited thereto, three results: a win, a draw, and a defeat. For example, feature data of a resource A and feature data of a resource B are compared with each other, and the comparison result is that the resource A wins.

In one embodiment, the remaining resources may be all remaining resources or some remaining resources. For example, the to-be-processed resources are resource A, resource B, resource C, resource D and resource E. For resource A, the remaining resources may be all remaining resources: the resource B, the resource C, the resource D and the resource E; or some remaining resources, such as the resource D and the resource E.

In particular, for each resource, the terminal may compare the feature data of the resource with feature data of each remaining resource, to obtain a result of a comparison of the feature data of the resource with feature data of each remaining resource. Therefore, the result of the comparison of the feature data of each resource with the feature data of each remaining resource is determined. In other words, a result of a comparison of feature data of two resources among the resources is determined. In this example embodiment, the feature data of each resource is compared with the feature data of each remaining resource. In this way, in a case that a probability that each resource wins over a group of the remaining resources is calculated, accuracy of a calculation result is greatly improved, ensuring accuracy of subsequent resource processing.

For example, the to-be-processed resources are resource A, resource B, and resource C. The terminal may compare feature data of the resource A with feature data of the resource B and feature data of the resource C, respectively, so as to obtain results of comparisons of the feature data of the resource A with the feature data of the resource B and the feature data of the resource C, respectively. The terminal may further compare the feature data of the resource B with the feature data of the resource A and the feature data of the resource C, respectively, so as to obtain results of comparisons of the feature data of the resource B with the feature data of the resource A and the feature data of the resource C, respectively. The terminal may further compare the feature data of the resource C with the feature data of the resource A and feature data of the resource B, respectively, so as to obtain results of comparisons of the feature data of the resource C with the feature data of the resource A and the feature data of the resource B, respectively. In this way, the terminal determines the result of a comparison of the feature data of each resource with the feature data of each remaining resource.

In one embodiment, the terminal may successively select each of the resources as a current resource, and randomly select a resource from remaining resources excluding a resource selected as the current resource. Then, the terminal compares feature data corresponding to the current resource with feature data corresponding to each selected resource, to obtain a result of a comparison of the feature data of the current resource with the feature data of each selected resource. In this example embodiment, in a case that each resource is compared with the remaining resources separately, some resources are selected for comparison by random sampling. Therefore, to-be-processed data amount is reduced, and data processing time is shortened. In this manner, in a case where there are a large number of to-be-processed resources, resource processing efficiency may be greatly improved.

For example, the to-be-processed resources are resource A, resource B, resource C, resource D and resource E. In a case that the terminal uses the resource A as a current resource, the terminal may randomly select a resource from the resource B, the resource C, the resource D and the resource E to be compared with the resource A, such as selecting the resource C and the resource D for comparison with the resource A. In a case that the terminal uses the resource B as the current resource, the terminal also randomly selects a resource from the resource A, the resource C, the resource D and the resource E for comparison with the resource B. In another example, the resource C and the resource D are selected for comparison with the resource B, and the resource D and the resource E may be further selected for comparison with the resource B, and the like, so as to reduce to-be-processed data amount through sampling and comparison and improve data processing efficiency.

It should be understood that a result of a comparison of feature data of one resource with feature data of another resource is relative and directional. For example, a result of a comparison of feature data of the resource A with feature data of the resource B refers to a result of a win, a draw, or a defeat relative to the resource A. A result of a comparison of the feature data of the resource B with the feature data of the resource A refers to a result of a win, a draw, or a defeat of the resource A relative to the resource B.

In one embodiment, the terminal may further successively select each of the resources as a current resource, and compares feature data corresponding to the current resource with feature data corresponding to each resource unselected as the current resource, to respectively obtain a result of a comparison of the feature data of the current resource with the feature data of each remaining resource that is unselected as the current resource. In turn, the result of a comparison of the feature data of each remaining resource that is unselected as the current resource with the feature data of the current resource is obtained. In this example embodiment, in a case that each resource is compared with the remaining resources separately, if a result of a comparison of two resources is obtained through a forward comparison, a backward comparison is no longer performed on the two resources. A result of the backward comparison is obtained directly according to a result of the forward comparison, preventing a repeated and redundant data processing process. Therefore, not only accuracy of a data processing result is ensured to a certain extent, but also to-be-processed data amount is reduced, and data processing efficiency is improved.

For example, the to-be-processed resources are resource A, resource B, and resource C. The terminal may compare feature data of the resource A with feature data of the resource B and feature data of the resource C, respectively, to obtain results of comparisons of the feature data of the resource A with the feature data of the resource B and the feature data of the resource C, respectively, and further obtain results of comparisons of the feature data of the resource B and the feature data of the resource C with the feature data of the resource A, respectively. The terminal may further compare the feature data of the resource B with the feature data of the resource C to obtain a result of a comparison of the feature data of the resource B with the feature data of the resource C, thereby obtaining a result of a comparison of the feature data of the resource C with the feature data of the resource B. In this way, the terminal determines the result of a comparison of the feature data of each resource with the feature data of each remaining resource.

A result of a comparison of feature data of two resources may be a result of a comparison of the feature data of the two resources obtained through a comparison function. The comparison function may be a preset non-linear function used for comparing the feature data of the two resources to obtain a comparison conclusion between the two resources. An independent variable of the comparison function is the feature data of the two resources, and a dependent variable of the comparison function is a result of the comparison of the feature data of the two resources.

It should be understood that because the result of a comparison of the feature data of the two resources are relative, a correspondence between the dependent variable and the independent variable of the comparison function may be set, that is, a result of a comparison of feature data of one resource with feature data of the other resource is obtained through calculation of the comparison function. For example, the comparison function is y=f(x1, x2), where x1 and x2 are independent variables and are feature data of two resources, and y is a dependent variable and is a result of a comparison of the feature data of the two resources. Then, in a case that a specific function relationship is constructed, y is set to be a result of the comparison of feature data of x1 with feature data of x2.

A result of a comparison of the feature data of the two resources may also be a result of a comparison of the feature data of the two resources obtained through a machine learning (ML) model. The machine learning model is a pre-trained model for comparing the feature data of two resources to output a comparison conclusion between the two resources. An input of the machine learning model is the feature data of the two resources, and an output of the machine learning model is the result of a comparison of the feature data of the two resources.

Similarly, it should be understood that during design of the machine learning model, a correspondence of a comparison between the output and the two inputs of the machine learning model, that is, the output is a result of a comparison of feature data of one resource with feature data of the other resource. The machine learning model may have a certain function through sample learning. The machine learning model may include a neural network model, a support vector machine, or a logistic regression model, etc. The neural network model includes such as a convolutional neural network, a back propagation neural network, a feedback neural network, a radial basis neural network, or a self-organizing neural network, etc.

S208: Determine, According to a Result Related to Each Resource, a Probability that Each Resource Wins Over a Group of Remaining Resources.

The probability of winning of a resource (or an object) through a comparison with a group of remaining resources (or other objects) represents a confidence level in which an object is superior to a plurality of objects compared with the object. As the probability of winning through a comparison with a group of remaining resources is greater, it indicates that the confidence level in which the object is superior to a plurality of objects is higher.

It should be understood that, in S206, the result of a separate comparison of the feature data of each resource with feature data of each remaining resource is a result of a separate comparison of two resources. In this way, for each resource, a terminal may use a pre-set evaluation function, and use, as an independent variable, the result of the separate comparison related to the resource, to obtain, through calculation, the confidence level in which the resource is superior to the remaining resources, that is, the probability that the resource wins through a comparison with a group of the remaining resources. For the pre-set evaluation function, in a case that a function relationship needs to meet a probability that a resource wins through a comparison with a group, a number of resources to which the resource is superior during a separate comparison is proportional to the probability that the resource wins through a comparison with a group. For example, the to-be-processed resources are resource A, resource B, and resource C. In an example scenario, a result of a comparison of feature data of the resource A with feature data of the resource B is a win, and a result of a comparison of the feature data of the resource A with feature data of the resource C is a defeat. Then, a probability that the resource A wins through a comparison with a group may be determined as 1/(1+1)=0.5.

In the foregoing resource processing method, after the to-be-processed resources are acquired, feature data corresponding to the resources may be searched for. Next, a result of a comparison of feature data of each resource with feature data of each remaining resource is determined. Therefore, a probability that each resource wins through a comparison with a group of remaining resources may be determined according to the result of a comparison of feature data related to each resource. In this way, an investor may select a resource according to the probability that each resource wins through a comparison with the group of the remaining resources, and then perform a subsequent operation. An entire process of resource processing requires no manual participation, improving resource processing efficiency.

In one embodiment, S206 includes the following operations: successively selecting each of the resources as a current resource; selecting a resource from the remaining resources excluding a resource selected as the current resource; jointly inputting, into a comparison model, feature data corresponding to the current resource and feature data corresponding to each selected remaining resource, to obtain a probability that the current resource wins through a separate comparison with each selected remaining resource; and determining, according to the probability that the current resource wins through a separate comparison with each selected remaining resource, a result of a comparison of the feature data of the current resource with the feature data of each selected resource, respectively.

The current resource represents a resource of which feature data is currently compared with feature data of other resources. The comparison model is a machine learning model with a comparison function through sample learning. In this example embodiment, the feature data may be feature data corresponding to a resource and belonging to all feature factors, or may be feature data corresponding to the resource and belonging to a part of the feature factors.

In particular, the terminal may acquire the comparison model obtained through training to compare feature data corresponding to the to-be-processed resources. The terminal may successively select each of the resources as a current resource, and perform the following operations on the current resource: selecting a part of resources from the remaining resources excluding a resource selected as the current resource, and then jointly inputting, into the comparison model, the feature data corresponding to the current resource and feature data corresponding to each selected remaining resource, to obtain a probability that the current resource wins through a separate comparison with each selected remaining resource. In this way, the terminal may determine, according to the probability that the current resource wins through a separate comparison with each selected remaining resource, a result of a comparison of the feature data of the current resource with the feature data of each selected remaining resource, respectively. The probability of winning through a separate comparison represents a confidence level in which one object is superior to another object when two objects are compared with each other. As the probability of winning through a separate comparison is greater, it indicates that the confidence level in which the object is superior to the other object is higher.

In one embodiment, the determining, according to the probability that the current resource wins through a separate comparison with each selected remaining resource, a result of a comparison of the feature data of the current resource with the feature data of each selected remaining resource, respectively, includes: determining, in a case that the probability that the current resource wins through a separate comparison with the selected remaining resource is greater than a first preset probability, that the result of a comparison of the feature data of the current resource with the feature data of the selected remaining resource is a win: determining, in a case that the probability that the current resource wins through a separate comparison with the selected remaining resource fails to reach the first preset probability and reaches or exceeds a second preset probability, that the result of a comparison of the feature data of the current resource with the feature data of the selected remaining resource is a draw; and determining, in a case that the probability that the current resource wins through a separate comparison with the selected remaining resource is less than the second preset probability, that the result of a comparison of the feature data of the current resource with the feature data of the selected remaining resource is a defeat.

The first preset probability and the second preset probability are preset probability thresholds for determining result types. It should be understood that two probability thresholds may be preset for the terminal. When the probability of winning through a separate comparison is higher than a probability threshold (a greater probability threshold) of the two probability thresholds (e.g., the first preset probability and the second preset probability), it is determined that the result of a comparison of the feature data is a win. When the probability of winning through a separate comparison is lower than the other probability threshold (a smaller probability threshold), it is determined that the result of a comparison of the feature data is a defeat. When the probability of winning through a separate comparison is between the first and the second probability thresholds, it is determined that the result of a comparison of the feature data is a draw. It should be understood that an output of the machine learning model (e.g., comparison model) may indicate a probability of a result used for reflecting a confidence level of the result.

For example, the to-be-processed resources are resource A, resource B, and resource C. In a case that the terminal uses the resource A as a current resource, feature data of the resource B and feature data of the resource A may be selected for comparison. In this case, the terminal inputs the feature data of the resource A and the feature data of the resource B into the comparison model, and the comparison model outputs a probability P_{A} that the resource A wins through a separate comparison with the resource B. The terminal may compare the P_{A} with a first preset probability P₁. When P_{A}>P₁, it is determined that a result of a comparison of the feature data of the resource A with the feature data of the resource B is a win. When P_{A}≥P₁, P_{A} is compared with a second preset probability P₂. When P₁≤P_{A}≤P₂, it is determined that the result of a comparison of the feature data of the resource A with the feature data of the resource B is a draw. When P_{A}<P₂, it is determined that the result of a comparison of the feature data of the resource A with the feature data of the resource B is a defeat.

For example, after feature data of two resources are input into the comparison model, GOAL_CMP_raw (the probability of winning through a separate comparison) output from the comparison model may be obtained. According to the first preset probability thres_U and the second preset probability thres_D, the GOAL_CMP_raw is converted into a standard symbol to determine GOAL_CMP (the result of a comparison of feature data). When GOAL_CMP_raw>thres_U, GOAL_CMP=1 (indicating that the result is a win). When GOAL_CMP_raw<thres_D, GOAL_CMP=−1 (indicating that the result is a defeat). When thres_U≤GOAL_CMP_raw≤thres_D, GOAL_CMP=0 (indicating that the result is a draw). Based on experience, thres_U=0.05 and thres_D=−0.05 may be set.

In this example embodiment, probabilities output by the comparison model are classified by uniformly setting the probability threshold, avoiding workload introduced during processing of a large number of different probabilities and avoiding a possible wrong determined result.

In this example embodiment, a result of a comparison is obtained through learning and comparison of feature data of the resources by using strong learning capability of the machine learning model, so that in a case that a probability of winning through a separate comparison between the resources is predicted through the comparison model and subsequent processing is performed. Accordingly, subjectivity caused by manual processing in evaluating the resources may be prevented, improving accuracy and objectivity of a processing result. In addition, in a case that each resource is compared with the remaining resources separately, some resources are selected for comparison by random sampling. Therefore, to-be-processed data amount is reduced, and data processing time is shortened. In a case of a large number of to-be-processed resources, resource processing efficiency may be greatly improved.

In one embodiment, S206 includes the following operations: successively selecting each of the resources as a current resource: jointly inputting, into a comparison model, feature data corresponding to the current resource and feature data corresponding to each resource unselected as the current resource, to obtain a probability that the current resource wins through a separate comparison with each resource unselected as the current resource; determining, according to the probability that the current resource wins through a separate comparison with each resource unselected as the current resource, a result of a comparison of the feature data of the current resource with the feature data of each resource unselected as the current resource, respectively; and determining, according to the result of a comparison of the feature data of the current resource with the feature data of each resource unselected as the current resource, a result of a comparison of the feature data of each resource unselected as the current resource with the feature data of the current resource, respectively.

In particular, the terminal may acquire the comparison model obtained through training to compare feature data corresponding to the to-be-processed resources. The terminal may successively select each of the resources as a current resource, and perform the following operations on the current resource: jointly inputting, into a comparison model, feature data corresponding to the current resource and feature data corresponding to each resource unselected as the current resource, to obtain a probability that the current resource wins through a separate comparison with each resource unselected as the current resource.

The terminal further determines, according to the probability that the current resource wins through a separate comparison with each resource unselected as the current resource, a result of a comparison of the feature data of the current resource with the feature data of each resource unselected as the current resource, respectively; and then determining, according to the result of a comparison of the feature data of the current resource with the feature data of each resource unselected as the current resource, a result of a comparison of the feature data of each resource unselected as the current resource with the feature data of the current resource, respectively.

In one embodiment, the determining, according to the probability that the current resource wins through a separate comparison with each resource unselected as the current resource, a result of a comparison of the feature data of the current resource with the feature data of each resource unselected as the current resource, respectively includes: determining, in a case that the probability that the current resource wins through a separate comparison with the resource unselected as the current resource is greater than a first preset probability, that the result of a comparison of the feature data of the current resource with the feature data of the resource unselected as the current resource is a win; determining, in a case that the probability that the current resource wins through a separate comparison with the resource unselected as the current resource fails to reach the first preset probability and reaches or exceeds a second preset probability, that the result of a comparison of the feature data of the current resource with the feature data of the resource unselected as the current resource is a draw; and determining, in a case that the probability that the current resource wins through a separate comparison with the resource unselected as the current resource is less than the second preset probability, that the result of a comparison of the feature data of the current resource with the feature data of the resource unselected as the current resource is a defeat.

It should be understood that definitions of the first preset probability and the second preset probability, and a processing manner of the results of a comparison of feature data obtained through comparisons of the probability of winning through a separate comparison with the first preset probability and the second preset probability are described in the foregoing example embodiments. Reference may be made to the foregoing processing manner, and the details are not described herein again.

In one embodiment, the determining, according to the result of a comparison of the feature data of the current resource with the feature data of each resource unselected as the current resource, a result of a comparison of the feature data of each resource unselected as the current resource with the feature data of the current resource, respectively includes: determining, in a case that the result of a comparison of the feature data of the current resource with the feature data of the resource unselected as the current resource is a win, that a result of a comparison of the feature data of each resource unselected as the current resource with the feature data of the current resource is a defeat; determining, in a case that the result of a comparison of the feature data of the current resource with the feature data of the resource unselected as the current resource is a draw, that a result of a comparison of the feature data of each resource unselected as the current resource with the feature data of the current resource is a draw: and determining, in a case that the result of a comparison of the feature data of the current resource with the feature data of the resource unselected as the current resource is a defeat, that a result of a comparison of the feature data of each resource unselected as the current resource with the feature data of the current resource is a win.

For example, the to-be-processed resources are resource A, resource B, and resource C. The terminal may jointly input feature data of the resource A and feature data of the resource B into the comparison model, the comparison model outputting a probability P_{A} that the resource A wins through a separate comparison with the resource B, and then the terminal compares the P_{A} with a first preset probability P₁. When P_{A}≥P₁, it is determined that a result of a comparison of the feature data of the resource A with the feature data of the resource B is a win, and it may be obtained that a result of a comparison of the feature data of the resource B with the feature data of the resource A is a defeat. When P_{A}≥P₁, P_{A} is compared with a second preset probability P₂. When P₁≤P_{A}≤P₂, it is determined that the result of a comparison of the feature data of the resource A with the feature data of the resource B is a draw, and it may be obtained that the result of a comparison of the feature data of the resource B with the feature data of the resource A is also a draw. When P_{A}<P₂, it is determined that the result of a comparison of the feature data of the resource A with the feature data of the resource B is a defeat, and it may be obtained that the result of a comparison of the feature data of the resource B with the feature data of the resource A is a win.

In this example embodiment, according to a mutual difference between two objects in results of comparisons during comparisons of the two objects, in a case that each resource is compared with the remaining resources separately, if a result of a comparison of the two resources is obtained through a forward comparison, a backward comparison is no longer performed on the two resources. A result of the backward comparison is obtained directly according to a result of the forward comparison, preventing a repeated and redundant data processing process. Therefore, not only accuracy of a data processing result is ensured to a certain extent, but also to-be-processed data amount is reduced, and data processing efficiency is improved.

In the foregoing example embodiment, a result of a comparison based on indicator data is obtained through learning and comparison of feature data of the resources by using strong learning capability of the machine learning model, so that in a case that a probability of winning through a separate comparison between the resources is predicted through the comparison model and subsequent processing is performed, subjectivity caused by manual processing in evaluating resources may be prevented, improving accuracy and objectivity of a processing result. In addition, in a case that each resource is compared with the remaining resources separately, if a result of a comparison of two resources is obtained through a forward comparison, a backward comparison is no longer performed on the two resources. A result of the backward comparison is obtained directly according to a result of the forward comparison, preventing a repeated and redundant data processing process. Therefore, not only accuracy of a data processing result is ensured to a certain extent, but also to-be-processed data amount is reduced, and data processing efficiency is improved.

In one embodiment, S202 includes the following operations: acquiring the to-be-processed resources, and a feature factor and an evaluation indicator on which the processing is based. S204 includes the following operations: searching for feature data corresponding to each of the resources and belonging to the feature factor, and acquiring a comparison model jointly corresponding to the feature factor and the evaluation indicator.

The feature factor is a parameter used for reflecting a category of the feature data. The feature data is a specific feature value belonging to the feature factor. For example, if the feature factor is a short-term resource share change ratio, the feature data belonging to the short-term resource share change ratio is 10%. In particular, for example, if the feature factor is a current-year tracking error, the feature data is 0.7986%. The evaluation indicator is a parameter used for evaluating a resource value. For example, a long-term resource share change ratio, a three-year tracking error and the like.

In one embodiment, the resources may be specifically financial assets. The feature factor may be specifically parameters that may be used for describing a feature of the financial assets, such as total financial assets, a financial asset profit, a current-year tracking error, and a current-period tracking error. The evaluation indicator may be specifically parameters used for evaluating a value of the financial assets such as an N-year tracking error, an N-year Sharpe ratio, and an N-year information ratio.

In particular, the terminal may provide a feature factor selection page, so that a feature factor is selected according to a selection instruction triggered by a user on the feature factor selection page. The terminal may also provide an evaluation indicator selection page, so that an evaluation indicator is selected according to a selection instruction triggered by the user on the evaluation indicator selection page.

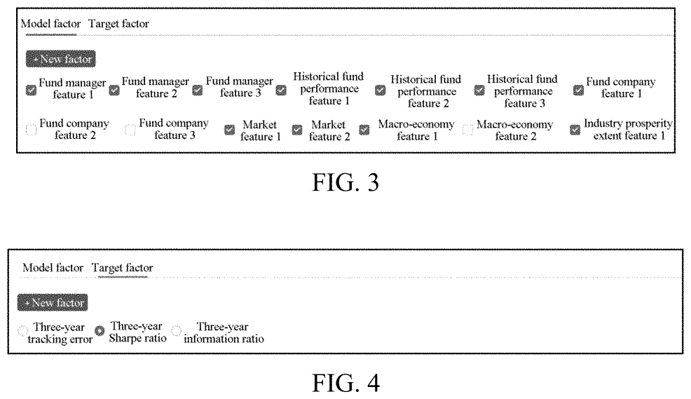

For example, the terminal may provide a financial asset rating system to display a feature factor (model factor) selection page configured for the system shown in FIG. 3. Referring to FIG. 3, an interface includes the feature factor (model factor). A user may select a feature factor (model factor) independently on the interface. A terminal may further display an evaluation indicator (target factor) selection page configured for the system shown in FIG. 4. Referring to FIG. 4, the interface includes the evaluation indicator (target factor). The user may select the evaluation indicator (target factor) independently on the interface.

Further, after acquiring the to-be-processed resources and the feature factor and evaluation indicator on which the processing is based, the terminal searches for feature data corresponding to the resources respectively and belonging to the feature factor, and acquires a comparison model jointly corresponding to the feature factor and the evaluation indicator.

It should be understood that the comparison model compares feature data belonging to the feature factor to obtain a result of a comparison of indicator data belonging to the evaluation indicator. In a case that the feature factors are A and B, and the evaluation indicator is C, the comparison model actually compares A and B of two resources to obtain a result of a comparison of C of two resources. It should be understood that in a case of acquisition of a model, the terminal acquires the comparison model jointly corresponding to the feature factor and the evaluation indicator.

In the foregoing example embodiment, the user may independently select the feature factor and evaluation indicator used for determining the comparison model, so that the resource may be analyzed from various aspects based on different feature factors or evaluation indicators, enhancing practicability and accuracy of a resource processing manner.

In one embodiment, an operation of generating the comparison model includes the following operations: acquiring a plurality of resource samples; collecting a feature data sample corresponding to the resource samples and belonging to the feature factor, and an indicator data sample corresponding to the resource samples and belonging to the evaluation indicator; respectively determining a result of a comparison of the indicator data sample of each resource sample with an indicator data sample of each remaining resource sample; using, as model training samples, feature data samples corresponding to any two resource samples, and using, as a corresponding training label, a result of a comparison of indicator data samples of the any two resource samples; and obtaining the comparison model through training according to the model training sample and the corresponding training label.

The resource samples are resources to which the model training samples belong. The feature data sample corresponding to the resource samples and belonging to the feature factor is input data in a case that the comparison model is trained, that is, the model training sample.

In particular, the terminal may respectively determine a result of a comparison of the indicator data sample of each resource sample with an indicator data sample of each remaining resource sample. Then, the terminal may use, as a model training sample, feature data samples corresponding to any two resource samples, and use, as a corresponding training label, a result of a comparison of indicator data samples of the two resource samples, so as to obtain, through training under a supervision the comparison model according to the model training sample and the corresponding training label.

For example, in a case that a resource sample identifier includes OBJ_1-OBJ_50, totaling 50 resource samples. The feature factors are FA, FB and FC, and the evaluation indicator is GOAL. Feature data corresponding to the 50 resource samples and belonging to the feature factors FA, FB and FC and indicator data belonging to the evaluation indicator GOAL are shown in the following table:

TABLE 1

| Resource | | | | |
|---|---|---|---|---|
| sample | | | | |
| identifier | FA | FB | FC | GOAL |
| OBJ_1 | 1.5 | 0.03 | 2.32 | 0.85 |
| OBJ_2 | 1.84 | −1.5 | 0.12 | 0.92 |
| OBJ_3 | 0.4 | −0.1 | 1.2 | 0.85 |
| . . . | . . . | . . . | . . . | . . . |
| OBJ_50 | 1.56 | 1.1 | −1.3 | 0.5 |

The terminal may successively select each of the resource samples as a current resource sample, and compare indicator data corresponding to the current resource sample with indicator data corresponding to each resource sample unselected as the current resource sample, to obtain a result of a separate comparison of the current resource sample with each resource sample unselected as the current resource sample respectively. The result is shown in the following table:

TABLE 2

| FA.1 | FA.2 | FB.1 | FB.2 | FC.1 | FC.2 | GOAL_CMP | Remark |
|---|---|---|---|---|---|---|---|
| 1.5 | 1.84 | 0.03 | −1.5 | 2.32 | 0.12 | −1 | OBJ_1(0.85) < OBJ_2(0.92) |
| 1.5 | 0.4 | 0.03 | −0.1 | 2.32 | 1.2 | 0 | OBJ_1(0.85) = OBJ_3(0.85) |
| . . . | . . . | . . . | . . . | . . . | . . . | . . . | . . . |
| 1.5 | 1.56 | 0.03 | 1.1 | 2.32 | −1.3 | 1 | OBJ_1(0.85) > OBJ_50(0.5) |
| 1.84 | 0.4 | −1.5 | −0.1 | 0.12 | 1.2 | 1 | OBJ_2(0.92)) > OBJ_3(0.85) |
| . . . | . . . | . . . | . . . | . . . | . . . | . . . | . . . |
| 1.84 | 1.56 | −1.5 | 1.1 | 0.12 | −1.3 | 1 | OBJ_2(0.92)) > OBJ_50(0.5) |
| . . . | . . . | . . . | . . . | . . . | . . . | . . . | . . . |

FA.1, FB.1 and FC.1 are feature data of one resource sample (X), FA.2, FB.2 and FC.2 are feature data of the other resource sample (Y), and GOAL_CMP is a result of a comparison of X with Y. GOAL_CMP is a symbol discrimination function. If X>Y, GOAL_CMP (X. Y)=1, indicating that X wins. If X=Y, GOAL_CMP (X, Y)=0, indicating that X draws with Y. If X<Y, GOAL_CMP (X, Y)=−1, indicating that X is defeated.

In particular, the terminal may further use FA.1, FB.1, FC.1, FA.2, FB.2, and FC.2 of any two resource samples as an input of a model, and use a corresponding GOAL_CMP as a training label to obtain, through training under supervision, the comparison model. Each set of input data (FA.1, FA.2, FB.1, FB.2, FC.1, and FC.2) of the comparison model is a set of partially ordered input data. The partially ordered input data defines a comparison relationship between two pieces of resource feature data in the input data. In other words, an output result is a result of a comparison of resource samples corresponding to FA.1, FB.1 and FC.1 with resource samples corresponding to FA.2, FB.2 and FC.2, and the output result is directional.

In one embodiment, the terminal may further acquire a time interval specified through a user instruction. Therefore, in a case that feature data is acquired, feature data corresponding to the resources and belonging to feature factors within the time interval is acquired respectively.

It should be understood that, in this way, the user may independently select the feature factor and evaluation indicator according to his or her needs, and obtain, through training, a corresponding comparison model that meets the needs. For example, for financial assets, the user focuses on the Sharpe ratio, and the user may use the Sharpe ratio as an evaluation indicator, and use, as the feature factor, a feature factor that may obtain a feature value of the financial assets, to train the comparison model. Then, prediction and evaluation are performed by using the comparison model obtained through training.

In the foregoing example embodiment, a training manner of the comparison model is provided, and comparison models corresponding to different feature factors and evaluation indicators are obtained by using feature data of a plurality of resource histories as a sample, indicator data of the resource histories as a label, and by objective data training. Therefore, in a case that a probability of winning through a separate comparison between the resources is predicted through the comparison model and subsequent processing is performed, subjectivity caused by manual processing in evaluating resources may be prevented, improving accuracy of a processing result.

In one embodiment, S208 includes the following operations: successively selecting each of the resources as a current resource; determining a first number of wins and a second number of defeats in a result related to the current resource; and obtaining, through calculation, by using the first number as a numerator and a sum of the first number and the second number as a denominator, the probability that the current resource wins through a comparison with the group of the remaining resources: or obtaining, through calculation, by using a difference between the first number and the second number as a numerator and a sum of the first number and the second number as a denominator, the probability that the current resource wins through a comparison with the group of the remaining resources.

The first number of wins in a result related to the current resource represents a number of the current resources in defeating other resources during a comparison of feature data of the current resources with feature data of other resources. The first number of defeats in the result related to the current resource represents a number of the current resources in being defeated by other resources during the comparison of the feature data of the current resources with the feature data of other resources.

In one embodiment, an evaluation function may be shown below:

$$\% PK ( A ) = \frac{{\sum }_{x} ( GOAL\_CMP ( A , x ) > 0 )}{{\sum }_{x} ( GOAL\_CMP ( A , x ) > 0 ) + {\sum }_{x} ( GOAL\_CMP ( A , x ) < 0 )} \qquad ( 1 )$$

% PK(A) is a probability that resource A wins through a comparison with a group of remaining resources (or a probability that resource A wins over the group of remaining resources), x is a resource in the remaining resources,

$${\sum }_{x} ( GOAL\_CMP ( A , x ) > 0 )$$

is a first number of wins in a result related to the resource A, and

$${\sum }_{x} ( GOAL\_CMP ( A , x ) < 0 )$$

is a second number of defeats in the result related to the resource A.

For example, the to-be-processed resources are resource A, resource B, and resource C. In an example scenario, a result of a comparison of feature data of the resource A with feature data of the resource B is a win, and a result of a comparison of the feature data of the resource A with feature data of the resource C is a defeat. In other words,

$${\sum }_{x} ( GOAL\_CMP ( A , x ) > 0 ) = 1 , \\ {\sum }_{x} ( GOAL\_CMP ( A , x ) < 0 ) = 1 ,$$

the probability that the resource A wins through a comparison with a group may be specifically 1/(1+1)=0.5.

In one embodiment, an evaluation function may be shown below:

$$\% PK ( A ) = \frac{{\sum }_{x} ( GOAL\_CMP ( A , x ) > 0 ) - {\sum }_{x} ( GOAL\_CMP ( A , x ) < 0 )}{{\sum }_{x} ( GOAL\_CMP ( A , x ) > 0 ) + {\sum }_{x} ( GOAL\_CMP ( A , x ) < 0 )} \qquad ( 2 )$$

In the foregoing example embodiment, various methods for calculating the probability of winning through a comparison with a group according to a probability of winning through a separate comparison is provided, so that calculation of the probability of winning of a resource through a comparison with a group of remaining resources is more flexible and diversified.

In one example, the resource processing method further includes the following operations: sorting the resources according to a determined probability of winning of a resource through a comparison with the group of remaining resources.

In particular, the terminal may sort the resources in descending order according to a determined probability of winning of a resource through a comparison with a group of remaining resources. During sorting, a resource with a higher probability of winning through a comparison with the group ranks higher, and a resource with a lower probability of winning through a comparison with the group ranks lower. In other words, a resource with the greatest probability of winning ranks top and a resource with the smallest probability of winning ranks bottom. The terminal may also sort the resources in ascending order according to a determined probability of winning through a comparison with a group of remaining resources. During sorting, a resource with a smallest probability of winning through a comparison with the group ranks top, and a resource with a greatest probability of winning through a comparison with the group ranks bottom.

In one embodiment, the sorting the resources according to a determined probability of winning through a comparison with the group includes: sorting the resources in descending order according to the determined probability of winning through a comparison with the group; and determining, according to sorted positions of the resources after the sorting, a classification level to which a corresponding resource belongs.

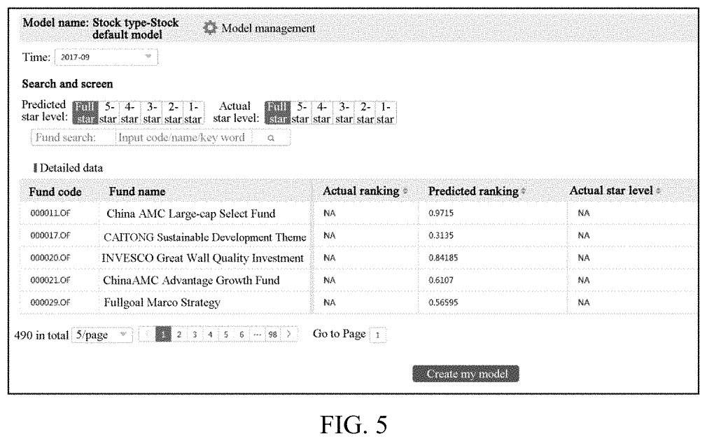

In particular, the terminal may sort the resources in descending order according to a determined probability of winning through a comparison with the group. During sorting, a resource with a greater probability of winning through a comparison with a group ranks higher, and a resource with a smaller probability of winning through a comparison with a group ranks lower. The terminal may further determine, according to sorted positions of the resources after the sorting, a classification level to which a corresponding resource belongs. For example, all resources are classified into five categories, top 20% being classified as a 5-star level, top 20%˜40% being classified as a 4-star level, top 40%˜60% being classified as a 3-star level, 60%˜80% being classified as a 2-star level, and bottom 20% being classified as a 1-star level. It should be understood that it is only described herein for illustrative purposes that all resources are classified into the five categories, and a classification manner and a number of classification categories or levels are not limited. For example, FIG. 5 shows a schematic diagram of an interface that displays a sorting result according to an example embodiment. Referring to FIG. 5, it may be seen that the interface includes sorted resource identifiers and probabilities that the resources win through comparisons with a group of remaining resources.

In this example embodiment, after the probabilities that the resources win through comparisons with a group of remaining resources are determined, the resources are sorted in descending order according to the determined probabilities of winning through a comparison with a group, and classification levels of the resources are determined, so as to reflect values of the resources through the resource ratings. In this manner, a user may rapidly determine to select a resource according to a level to which a resource belongs to and perform a subsequent operation.

In the foregoing example embodiment, in a case that the probabilities that the resources win through comparisons with a group of remaining resources, the resources may be sorted. The values of the resources are reflected in a visualized manner through a result of the sorting, helping the user select a resource subsequently and perform a subsequent operation.

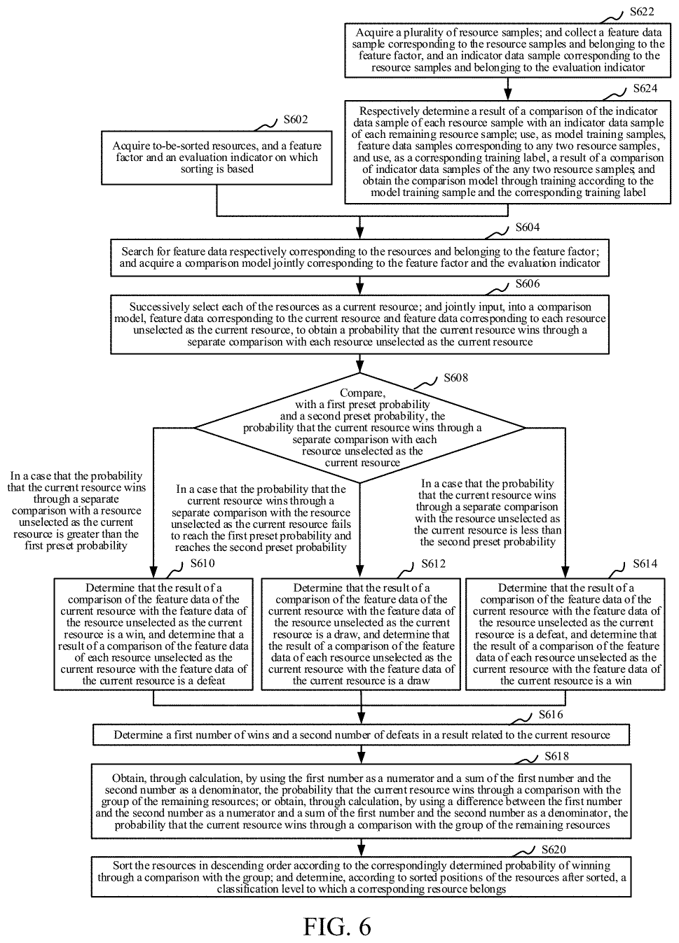

As shown in FIG. 6, in an example embodiment, a resource processing method specifically includes the following operations S602-S620.

S602: Acquire to-be-sorted resources, and a feature factor and an evaluation indicator on which sorting is based.

S604: Search for feature data corresponding to the resources respectively and belonging to the feature factor; and acquire a comparison model jointly corresponding to the feature factor and the evaluation indicator.

In particular, data acquired by a terminal is shown in the following table.

TABLE 3

| Resource | | | |
|---|---|---|---|
| identifier | FA | FB | FC |
| OBJ_1 | 3.2 | −1.3 | 2.1 |
| OBJ_2 | 2.1 | −2.1 | −0.1 |
| OBJ_3 | 1.2 | 1.5 | 0.5 |
| . . . | . . . | . . . | . . . |
| OBJ_20 | 0.3 | 0.07 | 1.1 |

The resource identifiers corresponding to the to-be-sorted resources are OBJ_1-OBJ_20, and the feature factors are FA, FB, and FC. It should be understood that a model completed through training is used for prediction, and then indicator data corresponding to the resources and belonging to the evaluation indicator is unknown.

S606: Successively select each of the resources as a current resource; and jointly input, into a comparison model, feature data corresponding to the current resource and feature data corresponding to each resource unselected as the current resource, to obtain a probability that the current resource wins through a separate comparison with each resource unselected as the current resource.

TABLE 4

| FA.1 | FA.2 | FB.1 | FB.2 | FC.1 | FC.2 | GOAL_CMP_raw | Remark |
|---|---|---|---|---|---|---|---|
| 3.2 | 2.1 | −1.3 | −2.1 | 2.1 | 0.1 | 0.5 | OBJ_1 VS OBJ_2 |
| 3.2 | 1.2 | −1.3 | 1.5 | 2.1 | 0.5 | −0.3 | OBJ_1VS OBJ_3 |
| . . . | . . . | . . . | . . . | . . . | . . . | . . . | . . . |
| 3.2 | 0.3 | −1.3 | 0.07 | 2.1 | 1.1 | 0.01 | OBJ_1 VS OBJ_20 |
| 2.1 | 1.2 | −2.1 | 1.5 | −0.1 | 0.5 | 0.18 | OBJ_2 VS OBJ_3 |
| . . . | . . . | . . . | . . . | . . . | . . . | . . . | . . . |
| 2.1 | 0.3 | −2.1 | 0.07 | −0.1 | 1.1 | 0.4 | OBJ_2 VS OBJ_20 |
| . . . | . . . | . . . | . . . | . . . | . . . | . . . | . . . |

In particular, a terminal successively selects each of the resources as a current resource: and combines feature data corresponding to the current resource with feature data corresponding to each resource unselected as the current resource to obtain a plurality of sets of partially ordered model-input data. Each row of data FA.1, FB.1, FC.1, FA.2, FB.2, and FC.2 in Table 4 is a set of partially ordered model-input data, and GOAL_CMP_raw is a probability of winning output by a comparison model through a separate comparison.

S608: Compare, with a first preset probability and a second preset probability, the probability that the current resource wins through a separate comparison with the resource unselected as the current resource: perform operation S610 in a case that the probability that the current resource wins through a separate comparison with the resource unselected as the current resource is greater than the first preset probability; perform operation S612 in a case that the probability that the current resource wins through a separate comparison with the resource unselected as the current resource fails to reach the first preset probability and reaches or exceeds the second preset probability: and perform operation S614 in a case that the probability that the current resource wins through a separate comparison with the resource unselected as the current resource is less than the second preset probability.

S610: Determine that the result of a comparison of the feature data of the current resource with the feature data of the resource unselected as the current resource is a win, and determine that a result of a comparison of the feature data of each resource unselected as the current resource with the feature data of the current resource is a defeat.

S612: Determine that the result of a comparison of the feature data of the current resource with the feature data of the resource unselected as the current resource is a draw, and determine that the result of a comparison of the feature data of each resource unselected as the current resource with the feature data of the current resource is a draw.

S614: Determine that the result of a comparison of the feature data of the current resource with the feature data of the resource unselected as the current resource is a defeat, and determine that the result of a comparison of the feature data of each resource unselected as the current resource with the feature data of the current resource is a win.

S616: Determine a first number of wins and a second number of defeats in a result related to the current resource.

S618: Obtain, through calculation, by using the first number as a numerator and a sum of the first number and the second number as a denominator, the probability that the current resource wins through a comparison with the group of the remaining resources: or obtain, through calculation, by using a difference between the first number and the second number as a numerator and a sum of the first number and the second number as a denominator, the probability that the current resource wins through a comparison with the group of the remaining resources.

S620: Sort the resources in descending order according to the probability of winning of respective resources through a comparison with the group of remaining resources: and determine, according to positions of the resources after being sorted, a classification level to which a corresponding resource belongs.

S622: Acquire a plurality of resource samples; and collect a feature data sample corresponding to the resource samples and belonging to the feature factor, and an indicator data sample corresponding to the resource samples and belonging to the evaluation indicator.

S624: Respectively determine a result of a comparison of the indicator data sample of each resource sample with an indicator data sample of each remaining resource sample; use, as model training samples, feature data samples corresponding to any two resource samples, and use, as a corresponding training label, a result of a comparison of indicator data samples of the any two resource samples; and obtain the comparison model through training according to the model training sample and the corresponding training label.

Operations of S622 and S624 may be performed before operation S604.

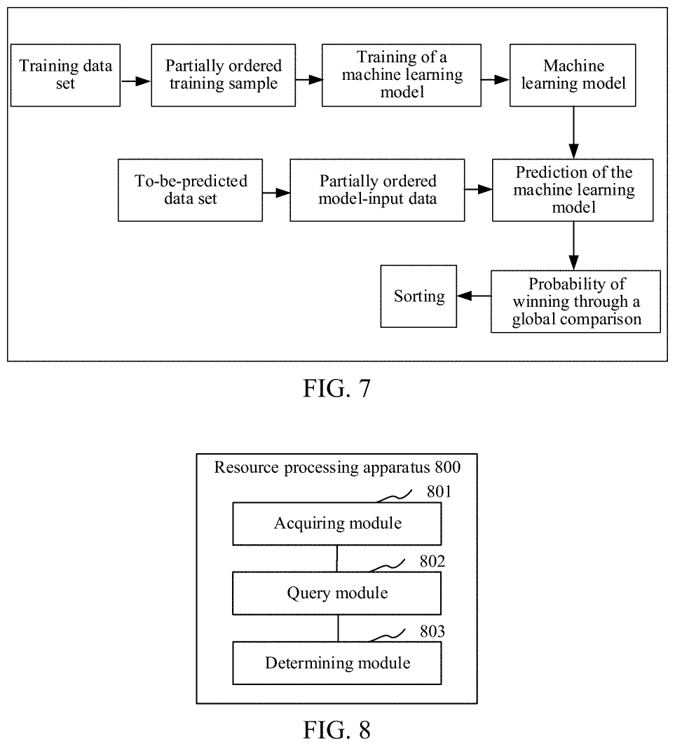

In particular, the resource processing method specifically includes two stages of training of a machine learning model and use of the machine learning model. As shown in FIG. 7, in the model training stage, the terminal may acquire a plurality resource samples; collect a feature data sample corresponding to the resource samples and belonging to the feature factor, and an indicator data sample corresponding to the resource samples and belonging to the evaluation indicator, to obtain a training data set. The terminal further respectively determines a result of a comparison of the indicator data sample of each resource sample with an indicator data sample of each remaining resource sample; and use, as model training samples, feature data samples corresponding to any two resource samples, and use, as a corresponding training label, a result of a comparison of indicator data samples of the any two resource samples, to obtain a partially ordered training sample for performing training on the machine learning model, thereby obtaining a trained machine learning model (comparison model). In the model use stage, the terminal acquires the to-be-sorted resources and the feature factor and evaluation indicator on which the sorting is based, and searches for feature data respectively corresponding to the resources and belonging to the feature factor, to obtain a to-be-predicted data set. The terminal successively selects each of the resources as a current resource; and jointly uses, as partially ordered model-input data, the feature data corresponding to the current resource and feature data corresponding to each resource unselected as the current resource, and obtains, through prediction, by using the machine learning model (comparison model), a probability that the current resource wins over remaining resources through a respective comparison, thereby obtaining a probability that the resource wins through a comparison with a group of the remaining resources. Therefore, the terminal sorts the resources in descending order according to the determined probability of winning through a comparison with the group.

It should be understood that although the operations in the flowcharts of the foregoing example embodiments are displayed in order indicated by arrow symbols, the operations are not necessarily performed in the order indicated by the arrow symbols. Unless clearly stated herein, the operations are not performed strictly in the order illustrated in the drawings, and the operations may be performed in other orders. Moreover, at least a part of the operations in the foregoing example embodiments may include a plurality of sub-operations or a plurality of stages. The sub-operations or stages are not necessarily performed at the same time, but may be performed at different times. The sub-operations or stages are not necessarily performed successively in order, but may be performed in turn or alternately with at least a part of other operations or sub-operations or stages of other operations.

As shown in FIG. 8, in one embodiment, a resource processing apparatus 800 is provided. Referring to FIG. 8, the resource processing apparatus 800) includes: an acquiring module 801, a query module 802, and a determining module 803. Modules included in the resource processing apparatus 800 may be implemented entirely or partly by software, hardware, or a combination thereof.

The acquiring module 801 is configured to acquire to-be-processed resources.

The query module 802 is configured to search for feature data corresponding to the resources respectively.

The determining module 803 is configured to determine a result of a respective comparison of the feature data of each resource with feature data of remaining resources; and determine, according to a result related to each resource, a probability that each resource wins through a comparison with a group of the remaining resources.

In one embodiment, the determining module 803 is further configured to successively select each of the resources as a current resource; select a resource from the remaining resources excluding a resource selected as the current resource: jointly input, into a comparison model, feature data corresponding to the current resource and feature data corresponding to each selected remaining resource, to obtain a probability that the current resource wins through a separate comparison with each selected remaining resource; and determine, according to the probability that the current resource wins through a separate comparison with each selected remaining resource, a result of a comparison of the feature data of the current resource with the feature data of each selected remaining resource, respectively.

In one embodiment, the determining module 803 is further configured to determine, in a case that the probability that the current resource wins through a separate comparison with the selected resource is greater than a first preset probability, that the result of a comparison of the feature data of the current resource with the feature data of the selected resource is a win; determine, in a case that the probability that the current resource wins through a separate comparison with the selected resource fails to reach the first preset probability and reaches or exceeds a second preset probability, that the result of a comparison of the feature data of the current resource with the feature data of the selected resource is a draw: and determine, in a case that the probability that the current resource wins through a separate comparison with the selected resource is less than the second preset probability, that the result of a comparison of the feature data of the current resource with the feature data of the selected resource is a defeat.

In one embodiment, the determining module 803 is further configured to successively select each of the resources as a current resource: jointly input, into a comparison model, feature data corresponding to the current resource and feature data corresponding to each resource unselected as the current resource, to obtain a probability that the current resource wins through a separate comparison with each resource unselected as the current resource; determine, according to the probability that the current resource wins through a separate comparison with each resource unselected as the current resource, a result of a comparison of the feature data of the current resource with the feature data of each resource unselected as the current resource, respectively; and determine, according to the result of a comparison of the feature data of the current resource with the feature data of each resource unselected as the current resource, a result of a comparison of the feature data of each resource unselected as the current resource with the feature data of the current resource, respectively.

In one embodiment, the determining module 803 is further configured to determine, in a case that the probability that the current resource wins through a separate comparison with the resource unselected as the current resource is greater than a first preset probability, that the result of a comparison of the feature data of the current resource with the feature data of the resource unselected as the current resource is a win; determine, in a case that the probability that the current resource wins through a separate comparison with the resource unselected as the current resource fails to reach the first preset probability and reaches or exceeds a second preset probability, that the result of a comparison of the feature data of the current resource with the feature data of the resource unselected as the current resource is a draw; and determine, in a case that the probability that the current resource wins through a separate comparison with the resource unselected as the current resource is less than the second preset probability, that the result of a comparison of the feature data of the current resource with the feature data of the resource unselected as the current resource is a defeat.

In one embodiment, the determining module 803 is further configured to determine, in a case that the result of a comparison of the feature data of the current resource with the feature data of the resource unselected as the current resource is a win, that a result of a comparison of the feature data of each resource unselected as the current resource with the feature data of the current resource is a defeat; determine, in a case that the result of a comparison of the feature data of the current resource with the feature data of the resource unselected as the current resource is a draw, that a result of a comparison of the feature data of each resource unselected as the current resource with the feature data of the current resource is a draw; and determine, in a case that the result of a comparison of the feature data of the current resource with the feature data of the resource unselected as the current resource is a defeat, that a result of a comparison of the feature data of each resource unselected as the current resource with the feature data of the current resource is a win.

In one embodiment, the acquiring module 801 is further configured to acquire the to-be-processed resources, and a feature factor and an evaluation indicator on which the processing is based. The query module 802 is further configured to search for feature data corresponding to the resources respectively and belonging to the feature factor; and acquire a comparison model jointly corresponding to the feature factor and the evaluation indicator.

In one embodiment, the resource processing apparatus 800 further includes a training module 805 configured to acquire a plurality of resource samples; collect a feature data sample corresponding to the resource samples and belonging to the feature factor, and an indicator data sample corresponding to the resource samples and belonging to the evaluation indicator; respectively determine a result of a comparison of the indicator data sample of each resource sample with an indicator data sample of each remaining resource sample: use, as model training samples, feature data samples corresponding to any two resource samples, and use, as a corresponding training label, a result of a comparison of indicator data samples of the any two resource samples; and obtain the comparison model through training according to the model training sample and the corresponding training label.

In one embodiment, the determining module 803 is further configured to successively select each of the resources as a current resource: determine a first number of wins and a second number of defeats in a result related to the current resource; and obtain, through calculation, by using the first number as a numerator and a sum of the first number and the second number as a denominator, the probability that the current resource wins through a comparison with the group of the remaining resources; or obtain, through calculation, by using a difference between the first number and the second number as a numerator and a sum of the first number and the second number as a denominator, the probability that the current resource wins through a comparison with the group of the remaining resources.

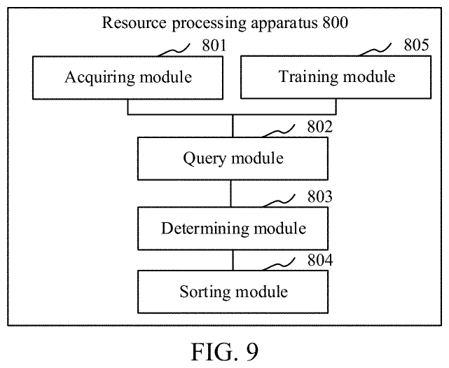

As shown in FIG. 9, in one embodiment, the resource processing apparatus 800 further includes: a training module 805 and a sorting module 804. The sorting module 804 is configured to sort the resources according to a determined probability of winning of a resource through a comparison with the group of remaining resources.

In one embodiment, the sorting module 804 is further configured to sort the resources in descending order according to the determined probability of winning of a resource through a comparison with the group of remaining resources: and determine, according to sorted positions of the resources after sorting, a classification level to which a corresponding resource belongs.

In one embodiment, the resources are financial assets: and the feature data is a feature value of the financial assets.

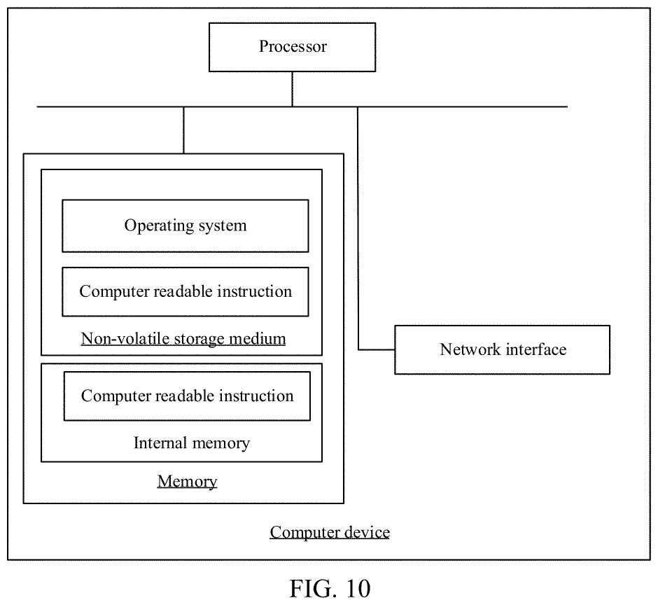

FIG. 10 shows an internal structure diagram of a computer device according to an example embodiment. The computer device may be the terminal 110 or the server 120 in FIG. 1. As shown in FIG. 10, the computer device includes a processor, a memory, and a network interface connected through a system bus. The memory includes a non-volatile storage medium and an internal memory. The non-volatile storage medium of the computer device stores an operating system and a computer-readable instruction that, when executed by the processor, causes the processor to implement a resource processing method. The internal memory may also store a computer-readable instruction that, when executed by the processor, causes the processor to perform the resource processing method. It should be understood by a person skilled in the art that the structure shown in FIG. 10 is only a block diagram of a part of the structure related to the solution of the disclosure, and does not constitute a limitation on the computer device to which the solution of the disclosure is applied. The computer device may include more or fewer components than components shown in the figure, or combine some components, or have a different component arrangement.

In one embodiment, the resource processing apparatus provided in the disclosure may be implemented in a form of a computer-readable instruction that may operate on the computer device shown in FIG. 10. The non-volatile storage medium of the computer device may store various instruction modules constituting the resource processing apparatus, such as the acquiring module 801, the query module 802, and the determining module 803 shown in FIG. 8. The computer-readable instruction including various instruction modules cause the processor to perform the operations in the resource processing method according to the embodiments of the disclosure described in this specification.

For example, the computer device shown in FIG. 10 may acquire to-be-processed resources through the acquiring module 801 through the resource processing apparatus 800 shown in FIG. 8. The query module 802 is configured to search for feature data corresponding to the resources respectively. The determining module 803 is configured to determine a result of a separate comparison of feature data of each resource with feature data of remaining resources; and determine, according to a result related to each resource, a probability that each resource wins through a comparison with a group of the remaining resources.

In an example embodiment, a computer device is provided, including: a memory and a processor, the memory storing computer-readable instructions, and the computer-readable instructions, when executed by the processor, causing the processor to perform the operations in the foregoing resource processing method. The operations in the resource processing method may be operations in the resource processing methods in the foregoing example embodiments.

In an example embodiment, a computer-readable storage medium is provided, storing computer-readable instructions, and the computer-readable instructions, when executed by the processor, causing the processor to perform the operations in the foregoing resource processing method. The operations in the resource processing method may be operations in the resource processing methods in the foregoing example embodiments.

A person of ordinary skill in the art should understand that some or all procedures in the method in the foregoing example embodiments may be implemented by a computer-readable instruction instructing related hardware, the program may be stored in a non-volatile computer readable storage medium, and when the program is executed, the procedures in the foregoing method embodiments may be implemented. Any reference to a memory, storage, database or another medium used in the various embodiments provided in the disclosure may include a non-volatile and/or volatile memory. The non-volatile memory may include, for example but not limited to, a read-only memory (ROM), a programmable ROM (PROM), an electrically programmable ROM (EPROM), an electrically erasable programmable ROM (EEPROM), or a flash memory. The volatile memory may include, for example but not limited to, a random access memory (RAM) or an external cache. By way of illustration and not limitation, the RAM is available in a variety of forms, such as a static RAM (SRAM), a dynamic RAM (DRAM), a synchronous DRAM (SDRAM), a dual data rate SDRAM (DDRSDRAM), an enhanced SDRAM (ESDRAM), a synchronization link (Synchlink) DRAM (SLDRAM), a memory Bus (Rambus) direct RAM (RDRAM), a direct memory bus dynamic RAM (DRDRAM), and a memory bus dynamic RAM (RDRAM).

The technical features in the foregoing example embodiments may be randomly combined. For concise description, not all possible combinations of the technical features in the embodiment are described. However, the combinations of the technical features are all to be considered as falling within the scope described in this specification provided that they do not conflict with each other.

At least one of the components, elements, modules or units described herein may be embodied as various numbers of hardware, software and/or firmware structures that execute respective functions described above, according to an example embodiment. For example, at least one of these components, elements or units may use a direct circuit structure, such as a memory, a processor, a logic circuit, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions, and executed by one or more microprocessors or other control apparatuses. Also, at least one of these components, elements or units may further include or implemented by a processor such as a central processing unit (CPU) that performs the respective functions, a microprocessor, or the like. Two or more of these components, elements or units may be combined into one single component, element or unit which performs all operations or functions of the combined two or more components, elements of units. Also, at least part of functions of at least one of these components, elements or units may be performed by another of these components, element or units. Further, although a bus is not illustrated in the block diagrams, communication between the components, elements or units may be performed through the bus. Functional aspects of the above example embodiments may be implemented in algorithms that execute on one or more processors. Furthermore, the components, elements or units represented by a block or processing operations may employ any number of related art techniques for electronics configuration, signal processing and/or control, data processing and the like.

The foregoing example embodiments only describe several implementations of the disclosure, which are described specifically and in detail, and therefore cannot be construed as a limitation to the patent scope of the disclosure. A person of ordinary skill in the art may make various changes and improvements without departing from the ideas of the disclosure, which shall all fall within the protection scope of the disclosure. Therefore, the protection scope of the patent of the disclosure shall be subject to the appended claims.

What is claimed is:

1. A resource processing method performed by a computer device, the method comprising:
searching for feature data respectively corresponding to a plurality of resources;
respectively determining, for each of the plurality of resources, a result of a comparison of feature data of a resource, among the plurality of resources, with feature data of each remaining resource among remaining resources; and
determining, based on the result of the comparison for each of the plurality of resources, a probability that each resource wins over the remaining resources.

2. The method according to claim 1, wherein the respectively determining the result of the comparison comprises:
successively selecting each of the plurality of resources as a current resource;
providing, to a comparison model, feature data corresponding to the current resource and feature data corresponding to each remaining resource, among remaining resources of the plurality of resources excluding a resource selected as the current resource, to obtain a probability that the current resource wins over each remaining resource; and
based on the probability that the current resource wins over each remaining resource, determining, for each of the remaining resources, a result of a comparison of the feature data of the current resource with the feature data of each of the remaining resources.

3. The method according to claim 2, wherein the determining the result of the comparison of the feature data of the current resource with the feature data of each of the remaining resources comprises:
based on the probability that the current resource wins over a remaining resource being greater than a first preset probability, determining that the result of a comparison of the feature data of the current resource with the feature data of the remaining resource is a win with respect to the current resource;
based on the probability that the current resource wins over the remaining resource being less than the first preset probability and equal to or greater than a second preset probability, determining that the result of the comparison of the feature data of the current resource with the feature data of the remaining resource is a draw with respect to the current resource; and
based on the probability that the current resource wins through a separate comparison with the remaining resource being less than the second preset probability, determining that the result of the comparison of the feature data of the current resource with the feature data of the remaining resource is a defeat with respect to the current resource.

4. The method according to claim 3, wherein the respectively determining the result of the comparison further comprises:
based on the result of the comparison of the feature data of the current resource with the feature data of the remaining resource being the win with respect to the current resource, determining that a result of a comparison of the feature data of the remaining resource with the feature data of the current resource is a defeat with respect to the remaining resource;
based on the result of the comparison of the feature data of the current resource with the feature data of the remaining resource being the draw with respect to the current resource, determining that the result of the comparison of the feature data of the remaining resource with the feature data of the current resource is a draw with respect to the remaining resource; and
based on the result of the comparison of the feature data of the current resource with the feature data of the remaining resource being the defeat with respect to the current resource, determining that the result of the comparison of the feature data of the remaining resource with the feature data of the current resource is a win with respect to the remaining resource.

5. The method according to claim 2, further comprising:
determining a feature factor and an evaluation indicator, related to processing the plurality of resources,
wherein the searching for the feature data comprises:
searching for the feature data corresponding to each of the plurality of resources and belonging to the feature factor; and
acquiring the comparison model jointly corresponding to the feature factor and the evaluation indicator.

6. The method according to claim 5, wherein the acquiring the comparison model comprises:
acquiring a plurality of resource samples:
collecting a feature data sample corresponding to each of the plurality of resource samples and belonging to the feature factor, and an indicator data sample corresponding to each of the plurality of resource samples and belonging to the evaluation indicator;
respectively determining a result of a comparison of an indicator data sample of each resource sample among the plurality of resource samples with an indicator data sample of each remaining resource sample; and
acquiring the comparison model through training based on model training samples and corresponding training labels, the model training samples comprising feature data samples corresponding to any two resource samples among the plurality of resource samples, and the corresponding training labels comprising a result of a comparison of indicator data samples of the any two resource samples.

7. The method according to claim 1, wherein the determining the probability comprises:
successively selecting each of the plurality of resources as a current resource;
determining, with respect to the current resource, a first number of wins and a second number of defeats based on a result of a comparison of the current resource with each remaining resource; and
determining the probability that the current resource wins over the remaining resources (i) by using the first number as a numerator and a sum of the first number and the second number as a denominator, or (ii) by using a difference between the first number and the second number as the numerator and the sum of the first number and the second number as the denominator.

8. The method according to claim 1, further comprising:
sorting each of the plurality of resources according to a probability of winning of each resource over the remaining resources.

9. The method according to claim 8, wherein the sorting comprises:
sorting each of the plurality of resources in descending order according to the probability of winning of each resource over the remaining resources; and
determining, based on a sorted position of each of the plurality of resources after the sorting, a classification level to which a corresponding resource belongs.

10. The method according to claim 1, wherein the plurality of resources are financial assets, and the feature data comprises a feature value of the financial assets.

11. A computer device comprising:
at least one memory configured to store program code; and
at least one processor configured to read the program code and operate as instructed by the program code, the program code comprising:
searching code configured to cause at least one of the at least one processor to search for feature data respectively corresponding to a plurality of resources:
first determining code configured to cause at least one of the at least one processor to respectively determine, for each of the plurality of resources, a result of a comparison of feature data of a resource, among the plurality of resources, with feature data of each remaining resource among remaining resources; and
second determining code configured to cause at least one of the at least one processor to determine, based on the result of the comparison for each of the plurality of resources, a probability that each resource wins over remaining resources excluding each resource.

12. The computer device according to claim 11, wherein the first determining code comprises:
code configured to cause at least one of the at least one processor to successively select each of the plurality of resources as a current resource;
code configured to cause at least one of the at least one processor to provide, to a comparison model, feature data corresponding to the current resource and feature data corresponding to each remaining resource, among remaining resources of the plurality of resources excluding a resource selected as the current resource, to obtain a probability that the current resource wins over each remaining resource; and
third determining code configured to cause at least one of the at least one processor to, based on the probability that the current resource wins over each remaining resource, determine, for each of the remaining resources, a result of a comparison of the feature data of the current resource with the feature data of each of the remaining resources.

13. The computer device according to claim 12, wherein the third determining code further causes at least one of the at least one processor to:
based on the probability that the current resource wins over a remaining resource being greater than a first preset probability, determine that the result of a comparison of the feature data of the current resource with the feature data of the remaining resource is a win with respect to the current resource;
based on the probability that the current resource wins over the remaining resource being less than the first preset probability and equal to or greater than a second preset probability, determine that the result of the comparison of the feature data of the current resource with the feature data of the remaining resource is a draw with respect to the current resource; and
based on the probability that the current resource wins through a separate comparison with the remaining resource being less than the second preset probability, determine that the result of the comparison of the feature data of the current resource with the feature data of the remaining resource is a defeat with respect to the current resource.

14. The computer device according to claim 13, wherein the third determining code further causes at least one of the at least one processor to:
based on the result of the comparison of the feature data of the current resource with the feature data of the remaining resource being the win with respect to the current resource, determine that a result of a comparison of the feature data of the remaining resource with the feature data of the current resource is a defeat with respect to the remaining resource;
based on the result of the comparison of the feature data of the current resource with the feature data of the remaining resource being the draw with respect to the current resource, determine that the result of the comparison of the feature data of the remaining resource with the feature data of the current resource is a draw with respect to the remaining resource; and
based on the result of the comparison of the feature data of the current resource with the feature data of the remaining resource being the defeat with respect to the current resource, determine that the result of the comparison of the feature data of the remaining resource with the feature data of the current resource is a win with respect to the remaining resource.

15. The computer device according to claim 12, wherein the program code further comprises:
fourth determining code configured to cause at least one of the at least one processor to determine a feature factor and an evaluation indicator, related to processing the plurality of resources, and
the searching code comprises:
second searching code configured to cause at least one of the at least one processor to search for the feature data corresponding to each of the plurality of resources and belonging to the feature factor; and
acquiring code configured to cause at least one of the at least one processor to acquire the comparison model jointly corresponding to the feature factor and the evaluation indicator.

16. The computer device according to claim 15, wherein the acquiring code comprises:
code configured to cause at least one of the at least one processor to acquire a plurality of resource samples;
code configured to cause at least one of the at least one processor to collect a feature data sample corresponding to each of the plurality of resource samples and belonging to the feature factor, and an indicator data sample corresponding to each of the plurality of resource samples and belonging to the evaluation indicator;
code configured to cause at least one of the at least one processor to respectively determine a result of a comparison of an indicator data sample of each resource sample among the plurality of resource samples with an indicator data sample of each remaining resource sample; and
code configured to cause at least one of the at least one processor to acquire the comparison model through training based on model training samples and corresponding training labels, the model training samples comprising feature data samples corresponding to any two resource samples among the plurality of resource samples, and the corresponding training labels comprising a result of a comparison of indicator data samples of the any two resource samples.

17. The computer device according to claim 11, wherein the second determining code comprises:
code configured to cause at least one of the at least one processor to successively select each of the plurality of resources as a current resource;
code configured to cause at least one of the at least one processor to determine, with respect to the current resource, a first number of wins and a second number of defeats based on a result of a comparison of the current resource with each remaining resource; and
code configured to cause at least one of the at least one processor to determine the probability that the current resource wins over the remaining resources (i) by using the first number as a numerator and a sum of the first number and the second number as a denominator, or (ii) by using a difference between the first number and the second number as the numerator and the sum of the first number and the second number as the denominator.

18. The computer device according to claim 11, wherein the program code further comprises:
sorting code configured to cause at least one of the at least one processor to sort each of the plurality of resources according to a probability of winning of each resource over the remaining resources.

19. The computer device according to claim 18, wherein the sorting code comprises:
code configured to cause at least one of the at least one processor to sort each of the plurality of resources in descending order according to the probability of winning of each resource over the remaining resources; and
code configured to cause at least one of the at least one processor to determine, based on a sorted position of each of the plurality of resources after the sorting, a classification level to which a corresponding resource belongs.

20. A non-transitory computer-readable storage medium storing computer code executable by at least one processor to cause the at least one processor to perform a resource processing method, the method comprising:
searching for feature data respectively corresponding to a plurality of resources;
respectively determining, for each of the plurality of resources, a result of a comparison of feature data of a resource, among the plurality of resources, with feature data of each remaining resource among remaining resources; and
determining, based on the result of the comparison for each of the plurality of resources, a probability that each resource wins over remaining resources excluding each resource.
